(19) United States
(12) Patent Application Publication
(10) Pub. No.: US 2008/0292387 A1
(43) Pub. Date: Nov. 27, 2008

(54) PAPER FASTENER PRONG COVER

(76) Inventor: Manuel ANG, San Clemente, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/184,849

(22) Filed: Aug. 1, 2008

Related U.S. Application Data
(63) Continuation-in-part of application No. 29/286,225, filed on Apr. 26, 2007, now Pat. No. D576681.

(51) Int. Cl. B42F 13/08

(52) U.S. Cl. 402/15

(57) ABSTRACT

Improvements in a paper fastener prong protector are disclosed. The protector works with existing malleable prongs that secure papers that are hole punched. The protector is essentially an elongated plastic part where the prongs are placed through the protects, the prongs are bent over into the protector and the cover of the protector is snapped shut to cover and protect the prongs. One or more tabs are depressed to release the top cover to allow for removal of the protector from the prongs for installing or removing sheets of paper on the prongs. The protector is then re-installed onto the prongs.

### CROSS REFERENCE TO RELATED APPLICATION

This application claims the benefit of Design application 29/286,225 filed Apr. 26, 2007 the entire contents of which is hereby expressly incorporated by reference herein.

### DESCRIPTION

1. Field of the Invention

This invention relates to improvements in a protective covering for paper fastener prongs. More particularly, the present protector works with existing malleable prongs that secure papers that are hole punched. The protector is essentially an elongated plastic part where the prongs are placed through the protects, the prongs are bent over into the protector and the cover of the protector is snapped shut to cover and protect the prongs. One or more tabs are depressed to release the top cover to allow for removal of the protector from the prongs for installing or removing sheets of paper on the prongs. The protector is then re-installed onto the prongs.

2. Background of the Invention

There are several systems for retaining loose papers. One method is to punch holes along at least one elongated side of each page and sliding the elongated legs of ductile blades through the holes of the sheets of paper. The ductile blades are then bent over the pages to secure the pages. The ductile blades are then bent over the loose pages to secure them together. The ends of the ductile blades are often free to bend or move. Several patents have issued that try to secure the ductile blades to prevent further undesirable moving and bending. Exemplary examples are provided herein.

U.S. Pat. No. 6,565,277 issued May 20, 2003 to Lien Wel Huang discloses a paper fastener having folded and shielded side edges. The paper fastener uses two parts comprising of a typical paper fastener made from ductile material having two legs extending from a base. A separate paper holder is slid over the legs and the legs are retained under slidable retainers. While these retainers help to prevent movement of the legs, the retainers are only located and locatable in two narrow locations along the long bent legs.

U.S. Pat. No. 5,338,126 issued Aug. 16, 1994 to Howard Mullin et al discloses a hinge binder device. This hinged bonder uses two separate hinged compartments for each of two leg portions of the anchoring member. The legs are prevented from overlapping each other because a spacing element is placed between the two hinged compartments. The hinged compartments snap closed in opposing faces to lock the covers in place. Recesses are located under each cover for a user to pry the lids covers open.

U.S. Pat. No. 4,979,841 issued Dec. 25, 1990 to John A. Lauder discloses a member for sheet binding staple. This paper fastener uses an existing base portion with two legs extending from a base. The sheet binding member is slid over the legs and the legs are retained under slidable holding clips. While these holding clips help to prevent movement of the legs, the holding clips are only located and locatable in two narrow locations along the long bent legs.

U.S. Pat. No. D459,395 issued Jun. 25, 2002 to Kanji Noguchi discloses a fastener where the ductile blade legs are bent outward from under the fastener. There is no protection of the outward turned legs, and there further is no cover that closes over the ductile legs to prevent damage from the legs.

What is needed is a paper fastener prong cover where the prongs can be bent into the prong cover and then covered to protect the ends of the legs. The prong cover should allow the legs to overlaps and also provide an overlapping closure to maintain the legs within the prong cover. A simple releasing mechanism should also be incorporated to release open each cover. The proposed application provides this solution in a single unit having a single cover using a living hinge to cover the legs, an overlapping seal and a release mechanism that easily opens the prong cover.

### BRIEF SUMMARY OF THE INVENTION

It is an object of the paper fastening prong cover to fabricate the prong cover is a homogeneous material such as plastic where the cover halves and the hinge is a single unit. The molding process is ideal because it reduces the number of parts involved in fabrication, inventory, storage and distribution. The molding process also allows for details to be imparted into the part to create hold down element and retainers.

It is an object of the paper fastening prong cover to utilize living hinges from the molding of the prong cover. The living hinge exists on an elongated side of the cover such that the cover bends as a single element. Additional living hinge(s) are utilized in the cover releasing mechanism that is pressed to release the upper portion of the cover from the lower portion of the cover.

It is another object of the paper fastening prong cover to utilize overlapping edges or features to protect the legs of the page retaining component. The over lapping edges or details further ensure that the legs are contained within the prong cover. Over lapping blade protector extends around the majority of the inside of the cover to provide both a seal and give structural strength to the two folding halves of the prong cover.

It is still another object of the paper fastening prong cover to utilize hinged levers to release the top from the bottom. When the top is closed on the bottom, the top is retained from opening because one or more hook(s) on the top half engage on a mating hook(s) on the bottom cover. In order to disengage the mating hook(s) a “U” shaped feature is depressed to move one or more hook(s) on the back housing out of the way of the hook(s) on the top housing whereby releasing the top cover from engagement in the bottom cover and thereby opening the top cover of the prong cover to expose the ductile legs for removal of the prong cover for installation or removal of retained paper(s).

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows the paper fastener prong cover installed and closed on paper.

FIG. 2 shows a top view of an opened paper fastener prong cover.

FIG. 3A-3C shows installation of a paper fastener prong cover.

FIG. 4A-3D shows the paper fastener being hinged closed.

FIG. 5A-5B shows a second preferred embodiment of the paper fastener prong cover.

### DETAILED DESCRIPTION

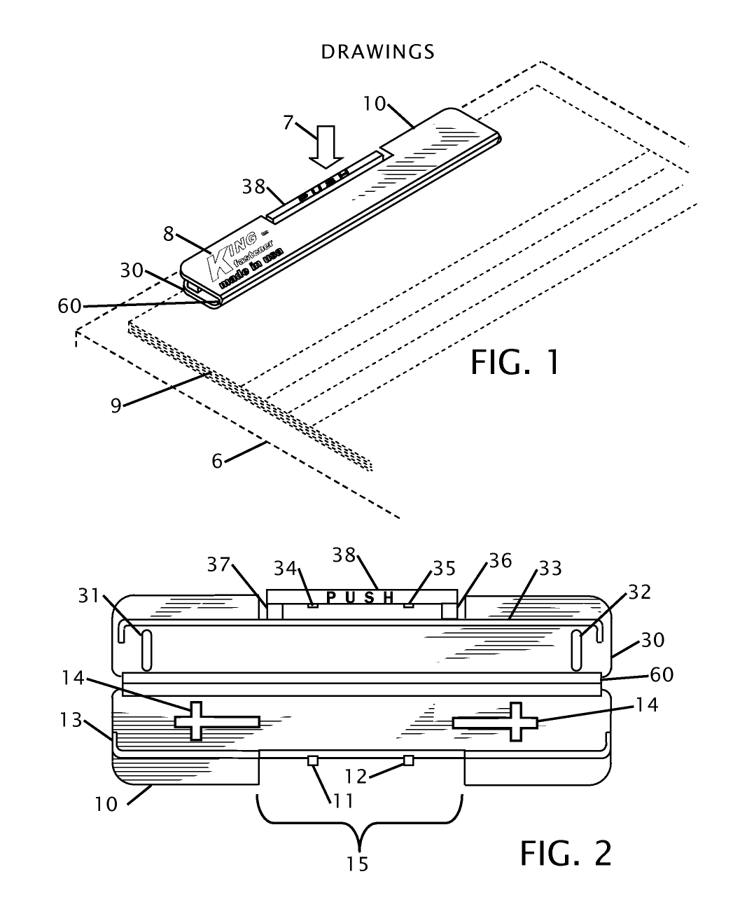

FIG. 1 shows the paper fastener prong cover installed and closed on paper(s) 9. This image is typical when the paper fastener prong cover is correctly installed onto a stack of papers 9 that have been punched with holes and retained on a “U” shaped paper anchor. The papers 9 are shown retained on a binder 6 or similar backing item. The paper fastener prong cover has a back member 30 and a top member 10 that are hingedly coupled with a living hinge 60. The paper fastener prong cover is made from a plastic material and is typically fabricated using an injection molding operation. A logo 8 is shown on one or more faces of the paper fastener prong cover. While a particular logo, icon or image is shown on the paper fastener prong cover this is being shown for illustration purposes and is not part of the claimed paper fastener prong cover. A “U” shaped releasing bar 7 is shown in this figure the “U” shaped releasing bar is depressed to release the top or front member 10 from the back member without requiring the user to “pry” the two parts apart. The operation of the “U” shaped releasing bar is shown and described in more detail in future figures herein.

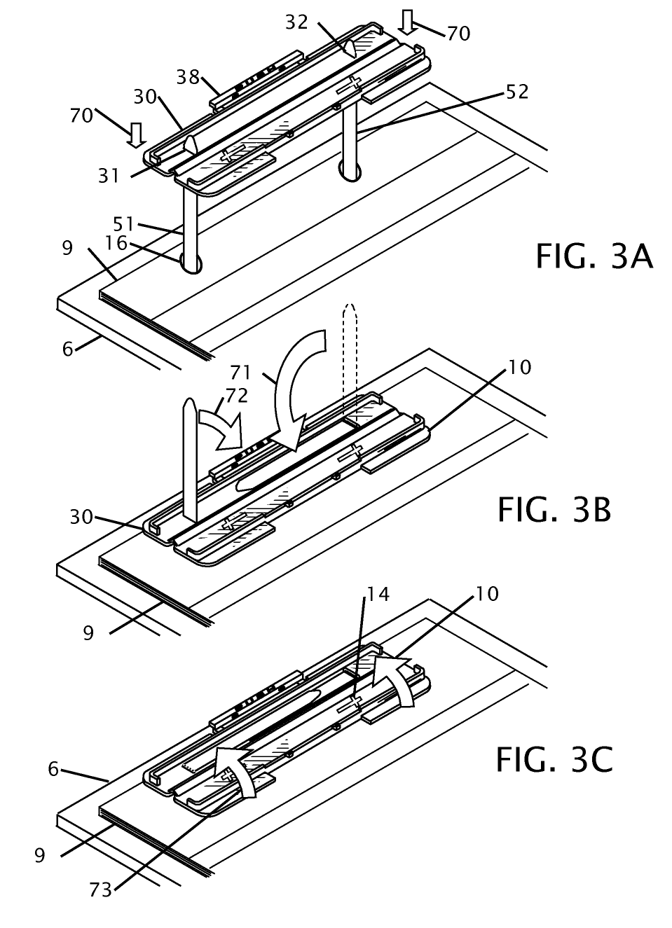

FIG. 2 shows a top view of an opened paper fastener prong cover. The various internal components are shown and described here in more detail to show their location and to better under sand their function. The paper fastener prong cover has a back member 30 that is attached to a top or front member 10 with a living hinge 60. The back member is essentially flat to rest upon, hold down and secure papers placed under the paper fastener prong cover. Two separate elongated holes 31 and 32 are shown in the back member. These holes extend through the back member and are configured with spacing that corresponds to legs of a ductile paper anchor. The legs are shown and described extending though these elongated holes 31 and 32 with FIGS. 3A-3C. A “U” shaped releasing bar 36-38 is connected to the back member. Hinge arms 36 and 37 are configured to bend on the back member. Two tabs 34 and 35 are located on the “U” shaped releasing bar. These two tabs 34 and 35 are configured to engage into tabs 11 and 12 on the front member 10 when the front member 10 is folded over and onto the back member 30. When the front member 10 is folded onto the back member the releasing bar 38 extends through the opening 15.

When the releasing bar 38 is depressed the hinge arms 36 and 37 will bend back and pull the tabs 34 and 35 out of engagement with tabs 11 and 12, thus releasing the front member form engagement with the back member 30. Text 8 is optionally printed or embossed into the releasing bar to identify where a user is to press to disengage the front member 10 form the back member 30. A raised rib 13 exists on the front member 10. A similar raised rib 33 exists on the back member 30. These ribs extend at least partially around the front and back members to retain the legs of the ductile paper anchor. These two raised ribs 13 and 33 are configured to nest next to each other to retain and protect the legs of the paper anchor when the paper fastener prong cover is in a closed configuration. Two raised details exist inside of the elongated holes 31 and 32 to further bend the legs of the “U” shaped paper anchor when the paper fastener prong cover is closed. These raised details 14 are shown in a cruciform configuration, but other shapes are contemplated including but not limited to rectangular, circular or triangular.

FIG. 3A-3C shows installation of a paper fastener prong cover. All item numbers are not identified in all of these three figures, but they should be taken as a series of figures showing a single installation. In FIG. 3A the paper fastener prong cover is brought over the two legs 51, 52 of a ductile paper anchor. The paper anchor has a number of sheets of paper 9 with holes 16 punched as a specific distance apart to correspond to the spacing of the legs 51 and 52. The paper anchor is secured to a pad, folder or other binder 6. The legs 51, 52 are shown partially inserted through elongated holes 31 and 32 in the back member 30. The release bar 38 is visible at the top of the back member 30. From this figure the paper fastener prong cover is brought down 70 onto the stack of paper 9

In FIG. 3B the paper fastener prong cover is shown resting on top of the stack of paper s 9. The back of the back member 30 is essentially flat to push upon the stack of paper(s) 9. The legs of the “U” shaped paper anchor are then bent 71, 72, one over the other. Depending upon the amount of paper 9 that is being retained the legs may or may not overlap.

In FIG. 3C the legs are shown bent down. The front member 10 is then folded 73 over the back member 30. When the front member 10 is folded over the back member 30 raised details 14 exert force onto the bent legs.

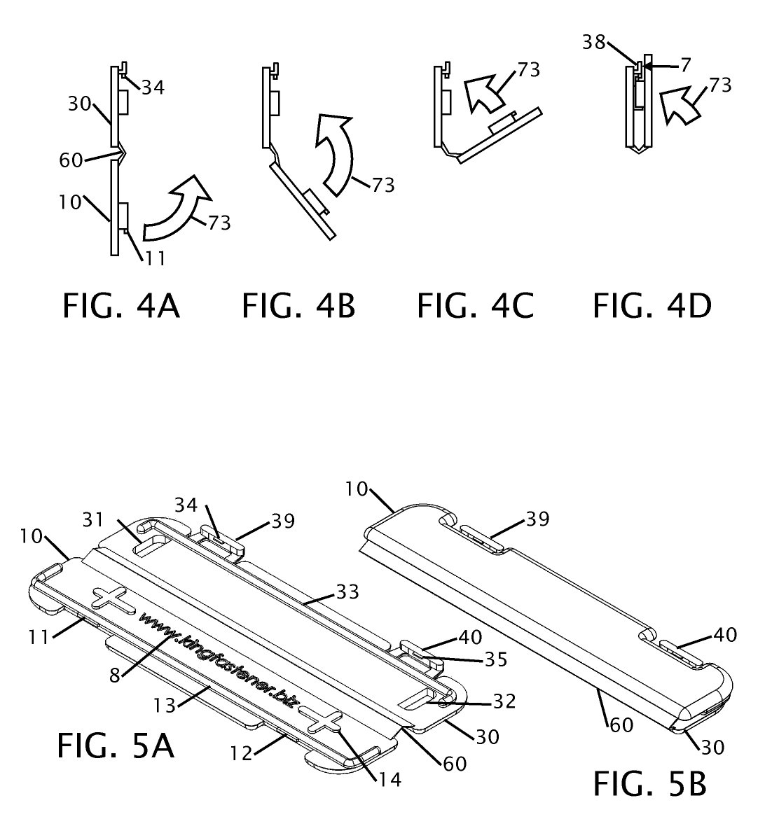

FIG. 4A-3D shows the paper fastener being hinged closed. All item numbers are not identified in all of these three figures, but they should be taken as a series of figures showing a single installation. In FIG. 4A the paper fastener prong cover is in an open configuration with the back member 30 essentially in-line with the front member 10. The living hinge 60 exists between the front member 10 and the back member 30. Tab 11 is shown on the front member 10 and tab 34 is shown on the back member 30. These two tabs 10 and 34 will engage upon each other to maintain the paper fastener prong cover in a closed configuration. In FIG. 4B the front member 10 is being hinged or folded 73. In FIG. 4C the front member 10 is shown being further hinged 73 forward. In FIG. 4D the front member 10 is secured onto the back member 30. The tabs 11 and 34 are engaged upon each other to prevent the front housing 10 from being dislodged from the back member 30. Depressing 7 the release bar 38 will move tab 34 back and tab 11 will be free to lift (or hinge) free from the back member.

FIG. 5A-5B shows a second preferred embodiment of the paper fastener prong cover. In this configuration the single “U” shaped locking and release bar is replaced with two separate “U” shaped locking and release bars. This configuration places the locking tabs 11, 12, 34, 35 at the more extreme ends of the paper fastener prong cover to retain the front member and reduce lifting of the ends of the front member 10. This configuration is similar to the configuration previously shown and described. The various internal components are shown and described here in more detail to show their location and to better under sand their function. The paper fastener prong cover has a back member 30 that is attached to a top or front member 10 with a living hinge 60. The back member is essentially flat to rest upon, hold down and secure papers placed under the paper fastener prong cover. Two separate elongated holes 31 and 32 are shown in the back member. These holes extend through the back member and are configured with spacing that corresponds to legs of a ductile paper anchor. “U” shaped releasing bars 39 and 40 are connected to the back member 30. The sides connecting arms of the releasing bars 39 and 40 are configured to bend on the back member. These two tabs 34 and 35 are configured to engage into tabs 11 and 12 on the front member 10 when the front member 10 is folded over and onto the back member 30. When the front member 10 is folded onto the back member the releasing bar 39 and 40 extend through openings in the front member.

When the releasing bars 39 and 40 are depressed the hinged connecting arms will bend back and pull the tabs 34 and 35 out of engagement with tabs 11 and 12, thus releasing the front member form engagement with the back member 30. Text 8 is optionally printed or embossed into the releasing bar to identify where a user is to press to disengage the front member 10 form the back member 30. A raised rib 13 exists on the front member 10. A similar raised rib 33 exists on the back member 30. These ribs extend at least partially around the front and back members to retain the legs of the ductile paper anchor. These two raised ribs 13 and 33 are configured to nest next to each other to retain and protect the legs of the paper anchor when the paper fastener prong cover is in a closed configuration. Two raised details exist inside of the elongated holes 31 and 32 to further bend the legs of the “U” shaped paper anchor when the paper fastener prong cover is closed. These raised details 14 are shown in a cruciform configuration, but other shapes are contemplated including but not limited to rectangular, circular or triangular.

Thus, specific embodiments of a paper fastener prong cover have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A paper fastener prong cover comprising:
an essentially flat back having a plurality of elongated holes for placement on a plurality of legs of a paper anchor;
a front member that is coupled to said back member with a living hinge;
said back member having a plurality of tabs located on at least one “U” shaped releasing bar that engage in corresponding mating tabs on said front member to create a closed condition;
said release bar provides a means for bending on said back member for the function of moving said plurality of tabs located on said at least one “U” shaped releasing bar that functions to move said plurality of tabs located on said at least one “U” shaped releasing bar out of engagement with said corresponding mating tabs on said front member to allow said front member to freely pivot open from said closed condition on said back member.

2. The paper fastener prong cover according to claim 1 wherein said legs of said “U” shaped paper anchor can fold on said elongated holes and be secured within said paper fastener prong cover.

3. The paper fastener prong cover according to claim 2 wherein said legs can rest on top of each other within said paper fastener prong cover.

4. The paper fastener prong cover according to claim 1 wherein said back member has a raised rib that extends around at least a portion of said back member to maintain at least one of said plurality of legs within said paper fastener prong cover.

5. The paper fastener prong cover according to claim 1 wherein said front member has a raised rib that extends around at least a portion of said front member to maintain at least one of said plurality of legs within said paper fastener prong cover.

6. The paper fastener prong cover according to claim 1 wherein said front member has a raised surface detail that presses on at least one of said plurality of legs when said paper fastener prong cover is in said closed condition.

7. The paper fastener prong cover according to claim 6 wherein said raised detail is in the shape of a cruciform, a rectangle, a square, a circle or a triangle.

8. The paper fastener prong cover according to claim 1 wherein said paper fastener prong cover is made from plastic.

9. The paper fastener prong cover according to claim 1 wherein said releasing bar is connected to said back member with a living hinge.

10. The paper fastener prong cover according to claim 1 wherein said front member has a raised rib that extends around at least a portion of said front member and said back member has a raised rib that extends around at least a portion of said back member, and said ribs are configured to nest with each other in said closed condition.

11. A paper fastener prong cover comprising:
an essentially flat back having a plurality of elongated holes for placement on a plurality of legs of a paper anchor;
a front member that is coupled to said back member with a living hinge;
said back member having a tabs located on each of two separate “U” shaped releasing bars that engage in corresponding mating tabs on said front member to create a closed condition;
said release bar provides a means for bending on said back member for the function of moving said of tabs located on each of said two separate “U” shaped releasing bar that functions to move said tabs located on said two separate “U” shaped releasing bar out of engagement with said corresponding mating tabs on said front member to allow said front member to freely pivot open from said closed condition on said back member.

12. The paper fastener prong cover according to claim 11 wherein said legs of said “U” shaped paper anchor can fold on said elongated holes and be secured within said paper fastener prong cover.

13. The paper fastener prong cover according to claim 12 wherein said legs can rest on top of each other within said paper fastener prong cover.

14. The paper fastener prong cover according to claim 11 wherein said back member has a raised rib that extends around at least a portion of said back member to maintain at least one of said plurality of legs within said paper fastener prong cover.

15. The paper fastener prong cover according to claim 11 wherein said front member has a raised rib that extends around at least a portion of said front member to maintain at least one of said plurality of legs within said paper fastener prong cover.

16. The paper fastener prong cover according to claim 11 wherein said front member has a raised surface detail that presses on at least one of said plurality of legs when said paper fastener prong cover is in said closed condition.

17. The paper fastener prong cover according to claim 16 wherein said raised detail is in the shape of a cruciform, a rectangle, a square, a circle or a triangle.

18. The paper fastener prong cover according to claim 11 wherein said paper fastener prong cover is made from plastic.

19. The paper fastener prong cover according to claim 11 wherein said releasing bar is connected to said back member with a living hinge.

20. The paper fastener prong cover according to claim 1 wherein said front member has a raised rib that extends around at least a portion of said front member and said back member has a raised rib that extends around at least a portion of said back member, and said ribs are configured to nest with each other in said closed condition.
